(19) United States
(12) Patent Application Publication
(10) Pub. No.: US 2005/0217167 A1
(43) Pub. Date: Oct. 6, 2005

(54) Fishing hook and lure, snag releasing

(76) Inventor: Thomas G. Packard, Edmonds, WA (US)

Correspondence Address: THOMAS G. PACKARD, 7005 150TH PL. SW., EDMONDS, WA, 98026, US

(21) Appl. No.: 11/089,299

(22) Filed: Mar. 24, 2005

Related U.S. Application Data
(60) Provisional application No. 60/559,126, filed on Apr. 2, 2004.
(60) Provisional application No. 60/564,419, filed on Apr. 22, 2004.
(60) Provisional application No. 60/605,611, filed on Aug. 30, 2004.

(51) Int. Cl. A01K 83/00

(52) U.S. Cl. 43/44.83; 43/43.16

(57) ABSTRACT

A snag releasing fishing hook and lure is made by constructing the hook and lure with an alternate/secondary line attachment point that is located behind the point/barb of the hook, such that if the main/primary line breaks from a debris/snag catch, the hook will twist/rotate and release from the catch by the function of the alternate/secondary line. If no secondary line is attached and the primary/main line is sufficiently strong the hook can be made fail and release from the snag without the loss of the lure.

### CROSS REFERENCE TO RELATED APPLICATIONS

PROVISIONAL APPLICATION 60/559,126 FILING DATE Apr. 2, 2004

PROVISIONAL APPLICATION 60/564,419 FILING DATE Apr. 22, 2004

PROVISIONAL APPLICATION 60/605,611 FILING DATE Aug. 30, 2004

### STATEMENT REGARDING FEDERALLY SPONSORED DEVELOPMENT

NOT APPLICABLE

### BACKGROUND OF THE INVENTION

Fishing is frequently interrupted and tackle is often lost due to fishing hooks and lures catching underwater snags, debris, rocks and etc.

The disclosed invention is a construction of hooks and lures that minimize and reduces this occurring problem.

### BRIEF DESCRIPTION OF THE INVENTION

A fishing hook or lure is constructed with two or more line attachment points, this will assist in release and retrieval from a debris/snag catch. When the hook initially cannot be freed and primary leader breaks from tension overload a secondary leader line that is attached to a secondary attachment point, which is located at the far end of the hook and behind the point and barb, will tighten and pull on the hook from behind the point/barb causing hook to rotate/twist thus reversing direction of the applied force and freeing the hook This general construction is applicable to a single, double, treble or multibarb hook and it is also applicable to a fishing lure or lures, the hook or hooks of which are of this construction that can be freed and saved in a similar manner.

In the above constructions where the secondary leader line can be attached to the bend of the hook, the hook can also be constructed, if desired, to fail at this location. When fishing and utilizing this feature of the hook a secondary line may not be required. The primary line could be significantly stronger than the hook and the hook/lure would be freed by the bending or breaking, failure, of the hook at the secondary/alternate line attachment location. This fishing scenario may require the use of a heavier primary fishing line than when utilizing an alternate/secondary line to free the hook

### DETAILED DESCRIPTION OF THE INVENTION

A fishing hook of various common design and size is constructed with Various incorporations/modifications. The hook will be constructed such that an additional leader line may be attached and fixed to a location on the hook that is behind the point and barb. This location will also be such that the distance behind the point and barb will be as long or great as possible without causing excessive leader line interference with the point and barb. These incorporations/modifications that allow for the attachment of the additional leader line may be of various constructions:

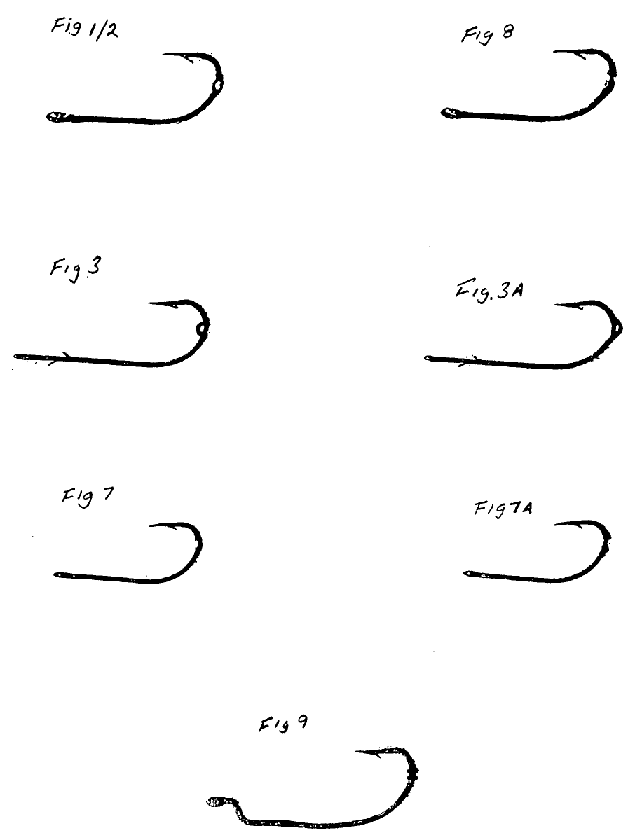

1. FIG. 1. A hole through the metal of the bend between the barb/head and shank that is perpendicular to the plane of the bend.

2 FIG. 2. A hole through the metal of the bend, in the middle or near the middle of the bend between barb/head and the shank, perpendicular to the plane of the bend. 3. FIG. 6. A hole through the metal of the bend, in the middle or near the middle of the bend between the barb/head and the shank that is in the plane of the bend.

4. FIG. 3. A small circular in line inside loop in the metal of the bend between the barb/head and the shank. 5. FIG. 3a. A small circular outside loop in the metal of the bend between the barb/head and the shank. 6. A small circular loop in the metal of the bend that is perpendicular to the plane of the bend.

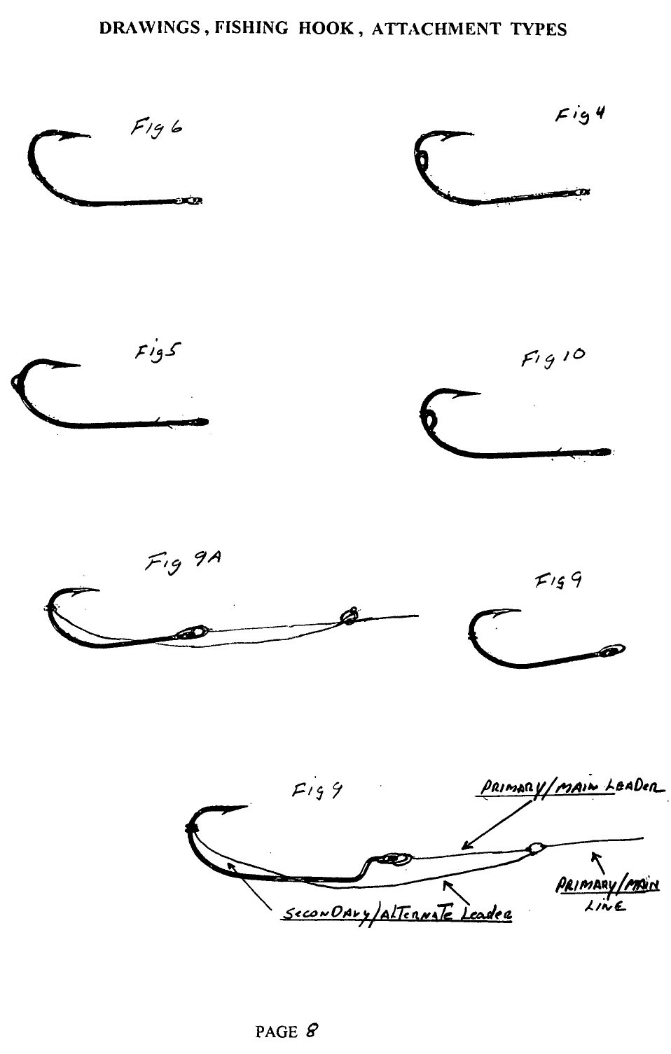

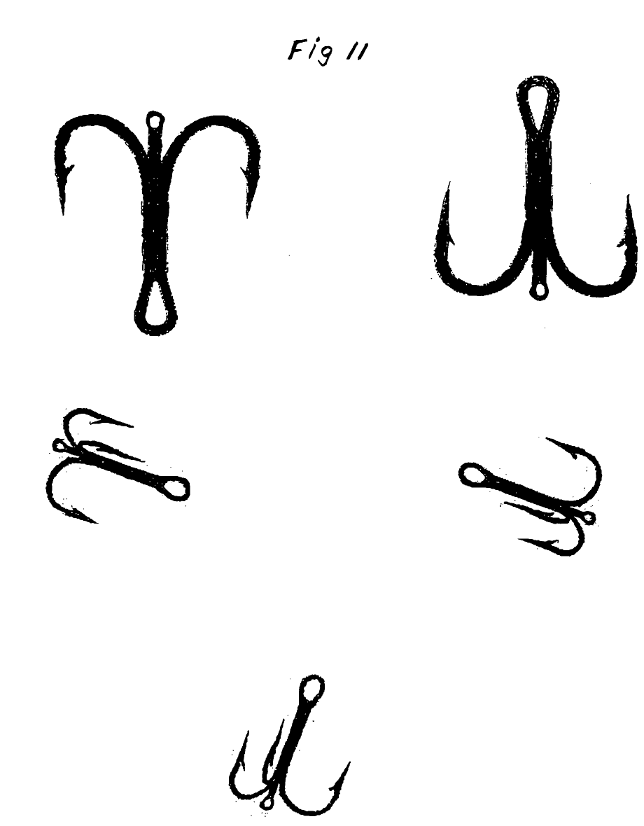

7. FIG. 7,7a. A small indentation in the metal of the bend on either the inside or outside or side, surface of the bend.

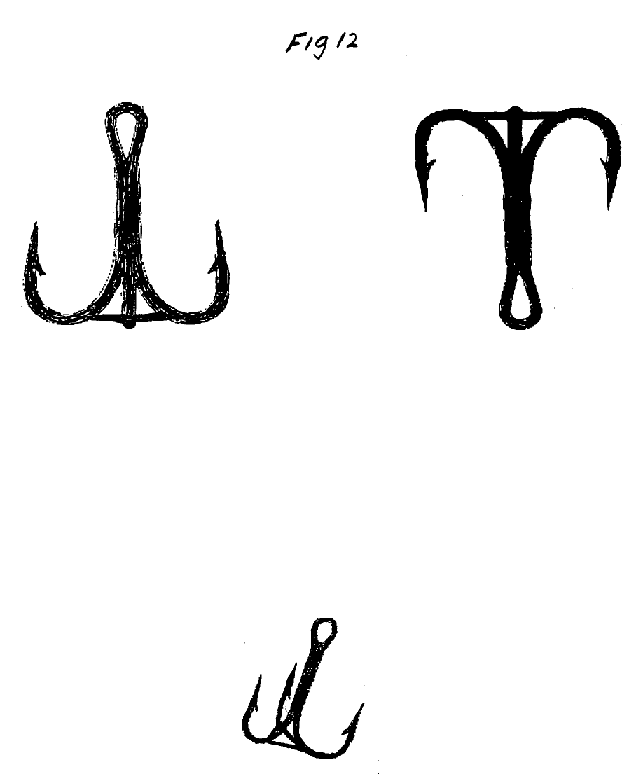

8. FIG. 8. Two small opposing indentations in the metal of the bend that are in the plane of the bend or perpendicular to the plane. 9. FIG. 9. Two small parallel, opposing stampings on either side of the bend and in line or parallel to the plane of the bend with a small separation for line attachment. 10. FIG. 4,5,10. A small ring or half ring of metal attached to the bend.

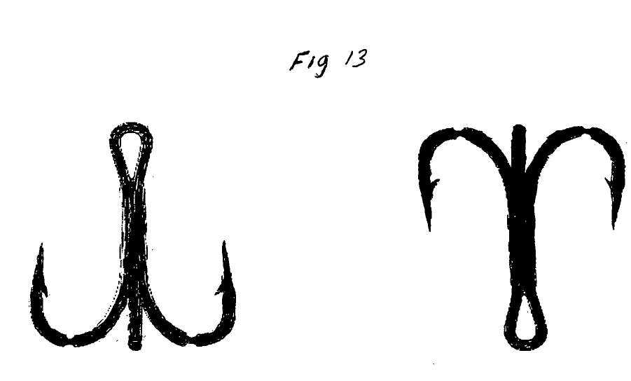

11. FIG. 11. If the hook is a treble, double or multi barb hook the type of construction and location of the attachment could be as above or there could be an Extension to the common shank, extending from the junction of separate Bends. The length of the extension would be such that the end would be in line with the far ends of the bends or longer. The terminating end of the extension would have an eye for the secondary/alternate leader line attachment

12. FIG. 12. Another type of construction for a double, treble or multi barb hook is to have a length of metal, wire extend or bridge from one of the bends to an adjacent bend and the secondary/alternate leader line would attach to it.

13. Some other construction to allow the alternate/secondary leader line to be attached to the hook as far as possible behind the point and barb without causing undue line interference with the point/barb and also without significantly interfering with the effective hooking functionality of the hook. The metal at the attachment location in the bend where the attachment location is on or essentially on the bend could be a little thicker, stronger, heavier if necessary to compensate for the disclosed modifications or if necessary could be made to fail, break, yield at the, FIG. 13 attachment location when a relatively high force is applied by a relative strong primary line. No leader or secondary/alternate line would be used when hook release is by hook failure or bending. If an alternate/secondary leader line is used it could be also be weakly attached to and held in place weakly on the shank and/or to the primary leader line adjacent to the hook eye by a small plastic or metal ring, spiral or clip/tab to keep the secondary/Alternate line away from the point/barb as much as possible. Another variation is to have the eye of the hook slightly enlarged, if necessary, to enable a loop in the secondary/alternate leader line to be threaded through and the primary leader line would transverse through the loop. The above general construction modifications/variations are also applicable to double hooks, treble hooks, multi point/barb hooks and hooks that are attached to spoons, spinners and lures in various degrees.

1. A fishing hook constructed such that a secondary, alternate or additional line can be attached and held to a point or Location on the hook that is behind the point or barb.

2. The fishing hook of claim 1, wherein the attachment point Is constructed into the hook and the point of attachment is on the bend of the Hook.

3. (canceled)

4. (canceled)

5. (canceled)

6. A fishing hook that is constructed to bend, break or fail when a predetermined load or force is applied to the hook through the attaching line.

7. A fishing lure the hook or hooks of which are constructed such that a secondary or alternate line may be attached to a point and location on the hook or hooks.

8. The lure of claim 7, wherein the attachment point for the secondary or alternate line is behind the point and barb of the hook or hooks.

9. A fishing lure the hook or hooks of which are of claim 6, wherein the lure is constructed with sufficient strength and such that the hooks may be readily replaced.

10. (canceled)

11. (canceled)

12. (canceled)

13. The fishing of hook claim 1, wherein the hook is a double, treble or multibarb hook that has an extension to the common shank extending behind or beyond the points and barbs. And the end of the extension has an eye or point for the attachment of the alternate or secondary or additional line.

14. The fishing hook of claim 1, wherein the hook is a double, treble or multibarb hook that has a connection or bridge between the bends, from one to the other.

15. The fishing lure of claim 7, wherein the lure is constructed to allow the alternate or secondary or additional line to pass through the lure or part of the lure.

16. The fishing lure of claim 7, wherein if the lure has a spinner the alternate or secondary line will traverse a tube or pass through a tube around which the spinner will rotate and attach to the hook or hooks.
